(19) United States
(12) Patent Application Publication
(10) Pub. No.: US 2024/0157278 A1
(43) Pub. Date: May 16, 2024

(54) FilterCover by CleanMyPool

(71) Applicant: Sunny Makati, Tampa, FL (US)

(72) Inventor: Sunny Makati, Tampa, FL (US)

(21) Appl. No.: 17/985,853

(22) Filed: Nov. 13, 2022

(51) Int. Cl. B01D 35/30; B01D 29/64

(52) U.S. Cl. CPC B01D 35/30; B01D 29/6438

(57) ABSTRACT

The present invention relates to a swimming pool filter which is designed to enhance the life of the pool's cartridge and sand filter from extremal harsh environmental conditions. The assembly is easy to install and remove and has openings formed to allow passage of the outwardly protruding inlet and outlet pipe. The protective cover includes fastening means to secure the filter apparatus's cylindrical body.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The field of the invention relates to swimming pools filters. More particularly, the field of the invention relates to providing protection to the swimming pool filter against harsh elements of the environment such as sun, wind, rain, and the like which causes the breakdown or shedding of fiberglass particles and extends the life of the Pool Filter Housing.

### Description of the Related Art

As owners of swimming pools know, in order to keep one's pool clean and sanitary, it is necessary that contaminates in the pool water need to be removed. Removal of these contaminates is usually accomplished by circulating the pool water through an exterior filter. In order to maintain a clean and sanitary pool or hot tub, the water requires daily filtering to remove dirt, debris, algae, and microbes. Many types of cartridges are used. Filter cartridges typically consist of 50 to 200 square feet of paper or fiber, folded accordion-style in a tightly packed 12″ diameter×36″ long tube, although larger filters can be used. Cartridge pool filters require routine cleaning or become blocked and ineffective. Manual cleaning of a filter is tedious and difficult, requiring the filter to be held and rotated by hand; all while washing the filter surfaces.

A pool filter is a component of a pool's filtration system that removes dirt and debris from the water. A pump pulls water to the filter, the filter removes dirt and debris, and then clean water is returned to the pool through return jets on the pool walls. There are three types of filters used for pools: sand, cartridge, and diatomaceous earth (DE). Cartridge filters trap contaminants by straining the water through paper-like materials; sand filters pump the water through sand, which captures many contaminant particles; and DE filters pump the water through a filter canister filled with DE, which has particles considerably finer than sand and with a structure better suited to capturing contaminants. Many pool owners and pool maintenance workers, therefore, consider DE filters to be the best type for residential swimming pools.

When examined under a microscope, diatomaceous earth (DE) powder reveals tiny sponge-like organisms that have a remarkable ability to absorb or filter water's impurities. Since the DE powder is so fine, it can filter microscopic contaminants from the water that passes through the filter. The DE used in pool filters has been heat-treated (calcinated) to give the silica a crystalline structure that improves its filtering ability. So-called food-grade DE is not the type used in pool filters. DE Filters.

Pool water comes from the circulation pump into the filter where small debris particles are removed through depth or surface filtration and then goes on to the heater or back to the pool.

A filter works through the mechanical separation of water and debris through surface or depth filtration. Sand filters use special filter sand, cartridge filters pass water through a fibrous element, and DE filters pass water through a thin layer of diatomaceous earth that is coated onto a grid.

A gauge located on the filter or valve can be used to measure the back pressure or resistance in your filter system. When the pressure increases by 10 psi, the filter should be cleaned to reduce resistance and improve water flow. Cartridge filters require disassembly and cleaning of the cartridge periodically to remove debris from the filter.

DE and Sand filters require periodic backwashing to remove debris from the filter. To accomplish this water is directed through the pool filter by a valve (multiport, vertical, or other). Once the water runs through the filter, it flows to the pool heater or back into the pool. To backwash, the valve is manipulated to reverse flow and direct debris-filled water to waste. Periodically the pool technician has to open the DE Filter from the side clamp to clean out the apparatus inside. Fortunately, for those with a cartridge-type filter system, maintaining the elements the tubes of folded, accordion-like material that goes inside the filter tank is easy to do.

Furthermore, sand type filter wherein water is forced through sand (or other filter material) removes the contaminants. One especially popular filter comprises a rather large cylindrical shaped apparatus, commonly three feet high and two to two and one-half feet in diameter. The top and bottom of the filter are hemispherical in shape, connecting with the cylinder, and a base attach to the bottom hemisphere to support the filter in an upright position. Filter medium such as sand is placed into the filter through an opening in the top hemispherical portion. This opening is generally five to six inches in diameter, threaded, and receives a likewise threaded top cap or bell which, when in place, seals the filter, Sand is placed into the pool filter apparatus through the opening in the top and removed through the same opening.

Water from the swimming pool is circulated to the filter by means of an inlet pipe and removed by an outlet pipe. These pipes are situated in the round cylindrical portion of the filter (although some filters have these pipes intersecting the top cap). Pool water is forcibly pumped into the filter by means of a motor-driven pump where it percolates through the sand and then is removed via the outlet pipe and returned to the swimming pool.

While the placement of the sand into the swimming pool filter apparatus might be rather easy, removal of the sand generally is not. Presently, removal of the sand or other filter medium by a pool service technician is accomplished by first removing the top cap, and then reaching in to scoop up the sand and remove it from the filter through the top opening. This is a tedious job and requires that the service technician's body come in contact with the outside of the filter in order to reach sand situated in the bottom of the filter. Furthermore, specific to sand filter cleaning—the filter has a clamp with bolt and nut that: has to be unfastened so the mechanism inside (grid set assembly) can get rinsed. The lid is held together by the bolt and clamp. Removal is a tedious job that requires the technician's body to come in contact with lid. After 6-18 months, DE powder can build up in places that can't be removed through routine backwash method so the whole apparatus has to be opened and cleaned out. The new DE powder is fed through the skimmer to coat the now clean grids in the DE Filter.)

The difficulty encountered with these types of cylindrical shaped swimming pool filters is that they are constructed of fiberglass and, since the filters are typically located outside in the environment, they are subject to damage from the elements, particularly bright sunlight. Sunlight, together with rain, ice, and wind and other harsh conditions, tend to break down the outside surface of the fiberglass material, releasing minute fiberglass particles which have the potentiality of being toxic. The problem most readily experienced by swimming pool service technicians is that the fiberglass particles shed by the filter enter the clothes worn by the technician to abrade the technician's skin causing, at the very least, intense itching. It is common for technicians to wash their clothes multiple times to remove these fiberglass particles or, after a short usage of the clothes, to discard them. There may also be the risk of inhaling these shed fiberglass particles with the attendant damage.

Thus to reduce the above-mentioned problems, the filter covers are used to provide maximum protection from external environmental factors. There are multiple advancements that have been presented in the prior art. However, these solutions are limited and restricted to their conventional systems. As a result of intensive studies on the above problems, the present inventor has found that the prior problems can be solved by a novel method of a filter pool cover. This solution creates and provide a high-quality, creative and practical solution that is easily integrated into this large and ever-growing industry. The filter cover is made to go over the Pool Filter Housing, can be easily installed and removed, and be able to have openings for PVC pipes to go through. For cartridge filters, it provides improved speed, improved convenience, improved compliance with periodic cleaning requirements and improved filter life.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims and abstract as a whole.

The primary desirable object of the present invention is to provide a novel and improved form of a simplest and most efficient approach of pool filter covers.

It is another object of the subject invention to provide a protective cover for a swimming pool filter apparatus against the harsh elements of an outside environment which might tend to degrade the structure of the filter apparatus.

It is also the primary objective of the invention to provide a design to cover pool filters conveniently.

It is another Objective of the invention to provide a solution that creates and provides a high-quality, creative and practical solution that can be easily, integrated to pool filters.

Another object of the present invention is a pool filter's cover which provides means in the subject inventive cover to permit the ingress and egress of the inlet and outlet pipes connecting to the outside shell of the filtering apparatus.

It is further the objective of the invention to prevent the technicians from hazardous situations by using the proposed assembly of a filter cover. Periodically the pool technician has to open the DE Filter from the side clamp to clean out the apparatus inside. The outside of the enclosure being made of fiberglass also can shed and becomes hazardous to the pool technician. Also the sand filter cleaning which has a clamp with bolt and nut that has to be unfastened so the mechanism inside (grid set assembly) can get rinsed. The lid that is held together by the boll: and clamp, Removal is a tedious job that requires technician's body to come in contact with the lid. After 6-18 months, DE powder can build up in places that can't be removed through routine backwash method so the whole apparatus has to be opened and cleaned out. Then new DE powder is fed through the skimmer to coat the now clean grids in the DE Filter.)

It is also the objective of the invention to provide a smart assembly, that provides ease of use and convenience to the user and provides ease of use to the user.

It is also the objective of the invention to provide an efficient and easy assembly that is cost-effective and convenient

Thus, it is the objective to provide advancement in process of providing pool filter covers. Other aspects, advantages and novel features of the present invention will become apparent from the detailed description of the invention when considered in conjunction with the accompanying claims.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention provides a novel method of where the proposed invention presents a set of innovations in pool filter covers.

The inventive filter apparatus covering device comprises a main body adapted to encircle the cylindrical portion of the filter apparatus, the main body comprising a rectangularly shaped flexible material in which openings have been formed to allow passage of the outwardly protruding inlet and outlet pipe. Further, the ends of the rectangularly shaped material have, on opposite sides, hook and loop type fastening material so that the main body of the invention is secured around the cylindrical portion of the filtering apparatus.

Additional embodiments of the invention include a less expensive and more easily constructed cover which may be made of paper, thin plastic sheet material or other inexpensive materials, but which will provide some protection to the pool serviceman and against harsh elements in the environment. Generally, these embodiments may be disposed of after just a few uses. In this additional embodiment, means are provided to completely enclose the filter apparatus through the use of a draw string situated at the bottom of the covering.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

I. An ergonomic design of the pool's filter cover comprising:
As per claim 1, the Cartridge Filter cover is disclosed;
As per claim 1, wherein the cover consists of Filter Cartridge Element and Outside Enclosure;
As per claim 1, the Filter cartridge element is replaceable for the life of the Outside Enclosure;
As per claim 1, the filter cover goes over the outside enclosure;
As per claim 1, the filter cartridge element is removed routinely to rinse off with a garden hose+nozzle;
As per claim 1, the filter cover is efficiently able to be taken off the outside enclosure to open and remove the filter cartridge element for cleaning;
As per claim 1, once cleaned, the filter cartridge element is placed back inside Outside Enclosure, closed and securely fastened; and,
As per claim 1, the filter cover goes over the outside enclosure and is securely fastened with fastening means including but not limited to zip, velcro etc.
